(19) United States
(12) Patent Application Publication
(10) Pub. No.: US 2005/0153856 A1
(43) Pub. Date: Jul. 14, 2005

(54) Methods and compositions for killing spores

(75) Inventors: Steffen Danielsen, Copenhagen Oe (DK); Eggert Christensen, Bagsvaerd (DK); Palle Schneider, Lynge (DK)

Correspondence Address: NOVOZYMES NORTH AMERICA, INC., 500 FIFTH AVENUE, SUITE 1600, NEW YORK, NY, 10110, US

(73) Assignee: Novozymes A/S, Bagsvaerd (DK)

(21) Appl. No.: 10/511,046

(22) PCT Filed: Apr. 25, 2003
(86) PCT No.: PCT/DK03/00273

(30) Foreign Application Priority Data
Apr. 25, 2002 (DK) PA 2002 00625
Aug. 30, 2002 (DK) PA 2002 01278

(51) Int. Cl. C11D 1/00

(52) U.S. Cl. 510/267

(57) ABSTRACT

The invention provides a sporocidal composition comprising a laccase or a compound exhibiting laccase activity, a source of oxygen, a source of iodide ions and an enhancing agenL A method of killing or inactivating spores and a method of decontaminating a location, which has been exposed to spores, are also disclosed.

### FIELD OF THE INVENTION

The present invention relates to enzymatic methods for killing or inactivating microbial spores.

### BACKGROUND

Spores are known to form from aerobic Bacilli, anaerobic Clostridia, selected sarcinae and a few actinomycetes. Spores resemble certain plant seeds in that they do not carry out any metabolic reactions. In this regard they are especially suited to withstand severe environmental stress and are known to survive prolonged exposures to heat, drying, radiation and toxic chemicals. These properties make spores especially difficult to kill in environments, like living tissue or objects which come in contact with living tissue, which would be adversely effected by extreme conditions.

Fungi, viruses and vegetative cells of pathogenic bacteria are sterilized within minutes at 70 degrees Celsius; many spores are sterilized at 100 degrees Celsius. However, the spores of some saprophytes can survive boiling for hours. Heat is presently the most commonly used means to insure sterilization of spores.

A particularly difficult problem relates to microbiocidal treatment of bacterial spore-forming microorganisms of the Bacillus cereus group.

Microorganisms of the Bacillus cereus group include Bacillus cereus, Bacillus mycoides, Bacillus anthracis, and Bacillus thuringiensis. These microorganisms share many phenotypical properties, have a high level of chromosomal sequence similarity, and are known enterotoxin producers.

Although all spore-forming microorganisms are problematic for microbiocidal treatments because they form spores, Bacillus cereus is one of the most problematic because Bacillus cereus has been identified as possessing increased resistance to germicidal chemicals used to decontaminate environmental surfaces.

Bacillus cereus is a particularly well-established enterotoxin producer and food-borne pathogen. This organism is frequently diagnosed as a cause of gastrointestinal disorders and has been suggested to be the cause of several foodborne illness outbreaks. The organism is ubiquitous in nature, and as a consequence, is present in animal feed and fodder. Due to its rapid sporulating capacity, the organism easily survives in the environment and can survive intestinal passage in cows. The organism can contaminate raw milk via feces and soil, and Bacillus cereus can easily survive the pasteurization process.

The present invention provides an improved enzymatic method for killing or inactivating spores.

### SUMMARY

The present invention provides as a first aspect a sporocidal composition comprising a laccase or a compound exhibiting laccase activity, a source of oxygen, a source of iodide ions and an enhancing agent.

In a second aspect is provided a method of killing or inactivating spores, comprising contacting the spores with the sporocidal composition of the invention.

In a third aspect is provided a method of decontaminating a location, which has been exposed to spores, comprising contacting the spores with the composition of the invention.

In a fourth aspect is provided a container comprising the composition of the invention, wherein the components of the composition are packaged in one or more compartments or layers.

In a fifth aspect is provided a ready-to-use sporocidal formulation comprising the composition of the invention.

In embodiments, the source of iodide may be one or more salts of iodide, such as sodium iodide or potassium iodide or mixtures thereof.

In other embodiments, the sporocidal composition of the invention further comprises a surfactant.

### DETAILED DESCRIPTION

Laccases and Compounds Exhibiting Laccase Activity

Compounds exhibiting laccase activity may be any laccase enzyme comprised by the enzyme classification EC 1.10.3.2 as set out by the Nomenclature Committee of the International Union of Biochemistry and Molecular Biology (IUBMB), or any fragment derived therefrom exhibiting laccase activity, or a compound exhibiting a similar activity, such as a catechol oxidase (EC 1.10.3.1), an o-aminophenol oxidase (EC 1.10.3.4), or a bilirubin oxidase (EC 1.3.3.5).

Preferred laccase enzymes and/or compounds exhibiting laccase activity are enzymes of microbial origin. The enzymes may be derived from plants, bacteria or fungi (including filamentous fungi and yeasts).

Suitable examples from fungi include a laccase derivable from a strain of Aspergillus, Neurospora, e.g., N. crassa, Podospora, Botrytis, Collybia, Fomes, Lentinus, Pleurotus, Trametes, e.g., T. villosa and T. versicolor, Rhizoctonia, e.g., R. solani, Coprinus, e.g., C. cinereus, C. comatus, C. friesii, and C. plicatilis, Psathyrella, e.g., P. condelleana, Panaeolus, e.g., P. papilionaceus, Myceliophthora, e.g., M. thermophila, Schytalidium, e.g., S. thermophilum, Polyporus, e.g., P. pinsitus, Phlebia, e.g., P. radita (WO 92/01046), or Coriolus, e.g., C. hirsutus (JP 2-238885).

Suitable examples from bacteria include a laccase derivable from a strain of Bacillus.

A laccase derived from Coprinus, Myceliophthora, Polyporus, Scytalidium or Rhizoctonia is preferred; in particular a laccase derived from Coprinus cinereus, Myceliophthora thernophila, Polyporus pinsitus, Scytalidium thermophilum or Rhizoctonia solani.

The laccase or the laccase related enzyme may furthermore be one which is producible by a method comprising cultivating a host cell transformed with a recombinant DNA vector which carries a DNA sequence encoding said laccase as well as DNA sequences encoding functions permitting the expression of the DNA sequence encoding the laccase, in a culture medium under conditions permitting the expression of the laccase enzyme, and recovering the laccase from the culture.

Determination of Laccase Activity (LACU)

Laccase activity (particularly suitable for Polyporus laccases) may be determined from the oxidation of syringaldazin under aerobic conditions. The violet colour produced is photometered at 530 nm. The analytical conditions are 19 mM syringaldazin, 23 mM acetate buffer, pH 5.5, 30° C., 1 min. reaction time.

1 laccase unit (LACU) is the amount of enzyme that catalyses the conversion of 1.0 mmole syringaldazin per minute at these conditions.

Determination of Laccase Activity (LAMU)

Laccase activity may be determined from the oxidation of syringaldazin under aerobic conditions. The violet colour produced is measured at 530 nm. The analytical conditions are 19 mM syringaldazin, 23 mM Tristmaleate buffer, pH 7.5, 30° C., 1 min. reaction time.

1 laccase unit (LAMU) is the amount of enzyme that catalyses the conversion of 1.0 mmole syringaldazin per minute at these conditions.

Source of Oxygen

The source of oxygen required by the laccase or the compound exhibiting laccase activity may be oxygen from the atmosphere or an oxygen precursor for in situ production of oxygen. Oxygen from the atmosphere will usually be present in sufficient quantity. If more O₂ is needed, additional oxygen may be added, e.g. as pressurized atmospheric air or as pure pressurized O₂.

Source of Iodide Ions

According to the invention the source of iodide ions needed for the reaction with the laccase may be achieved in many different ways, such as by adding one or more salts of iodide. In a preferred embodiment the salt of iodide is sodium iodide or potassium iodide, or mixtures thereof.

The concentration of the source of iodide ions will typically correspond to a concentration of iodide ions of from 0.01 mM to 1000 mM, preferably from 0.05 mM to 500 mM, and more preferably from 0.1 mM to 100 mM.

Enhancing Agent

The enhancing agent may be selected from the group consisting of aliphatic, cyclo-aliphatic, heterocyclic or aromatic compounds containing the moiety >N—OH. In a preferred embodiment of the invention the enhancing agent is a compound of the general formula I: 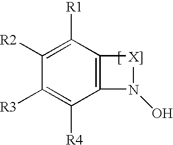
wherein R¹, R², R³, R⁴ are individually selected from the group consisting of hydrogen, halogen, hydroxy, formyl, carboxy and salts and esters thereof, amino, nitro, C₁₋₁₂-alkyl, C₁₋₆-alkoxy, carbonyl(C₁₋₁₂-alkyl), aryl, in particular phenyl, sulfo, aminosulfonyl, carbamoyl, phosphono, phosphonooxy, and salts and esters thereof, wherein the R¹, R², R³, R⁴ may be substituted with R⁵, wherein R⁵ represents hydrogen, halogen, hydroxy, formyl, carboxy and salts and esters thereof, amino, nitro, C₁₋₁₂-alkyl, C₁₋₆-alkoxy, carbonyl(C₁₋₁₂-alkyl), aryl, in particular phenyl, sulfo, aminosuifonyl, carbamoyl, phosphono, phosphonooxy, and salts and esters thereof;
[X] represents a group selected from (—N═N—)ₘ, (—N═CR⁶—)ₘ, (—CR⁶═N—)ₘ, (—CR⁷═CR⁶—)ₘ(—CR⁶═N—NR⁷—), (—N═N—CHR⁶—), (—N═CR⁶—NR⁷—), (—N═CR⁶—CHR⁷—), (—CR⁶═N—CHR⁷—), (—CR⁶═CR⁷—NR⁸—), and (—CR⁶═CR⁷—CHR⁸13 ), wherein R⁶, R⁷, and R⁸ independently of each other are selected from H, OH, NH₂, COOH, SO₃H, C₁₋₆-alkyl, NO₂, CN, Cl, Br, F, CH₂OCH₃, OCH₃, and COOCH₃; and m is 1 or 2.

The term “C₁₋ₙ-alkyl” wherein n can be from 2 through 12, as used herein, represent a branched or straight alkyl group having from one to the specified number of carbon atoms. Typical C₁₋₆-alkyl groups include, but are not limited to, methyl, ethyl, n-propyl, iso-propyl, butyl, iso-butyl, sec-butyl, tert-butyl, pentyl, iso-pentyl, hexyl, iso-hexyl and the like.

In a more preferred embodiment of the invention the enhancing agent is a compound of the general formula II: 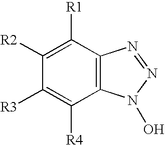
wherein R¹, R², R³, R⁴ are individually selected from the group consisting of hydrogen, halogen, hydroxy, formyl, carboxy and salts and esters thereof, amino, nitro, C₁₋₁₂-alkyl, C₁₋₆-alkoxy, carbonyl(C₁₋₁₂-alkyl), aryl, in particular phenyl, sulfo, aminosulfonyl, carbamoyl, phosphono, phosphonooxy, and salts and esters thereof, wherein the R¹, R², R³, R⁴ may be substituted with R⁵, wherein R⁵ represents hydrogen, halogen, hydroxy, formyl, carboxy and salts and esters thereof, amino, nitro, C₁₋₁₂-alkyl, C₁₋₆-alkoxy, carbonyl(C₁₋₁₂-alkyl), aryl, in particular phenyl, sulfo, aminosulfonyl, carbamoyl, phosphono, phosphonooxy, and salts and esters thereof.

The enhancing agent may also be a salt or an ester of formula I or II.

Further preferred enhancing agents are oxoderivatives and N-hydroxy derivatives of heterocyclic compounds and oximes of oxo- and formyl-derivatives of heterocyclic compounds, said heterocyclic compounds including five-membered nitrogen-containing heterocycles, in particular pyrrol, pyrazole and imidazole and their hydrogenated counterparts (e.g. pyrrolidine) as well as triazoles, such as 1,2,4-triazole; six-membered nitrogen-containing heterocycles, in particular mono-, di- and triazinanes (such as piperidine and piperazine), morpholine and their unsaturated counterparts (e.g. pyridine and pyrimidine); and condensed heterocycles containing the above heterocycles as substructures, e.g. indole, benzothiazole, quinoline and benzoazepine.

Examples of preferred enhancing agent from these classes of compounds are pyridine aldoximes; N-hydroxypyrrolidinediones such , as N-hydroxysuccinimide and N-hydroxyphthalimide; 3,4-dihydro-3-hydroxybenzo[1,2,3]triazine-4-one; formaldoxime trimer (N,N′,N″-trihydroxy-1,3,5-triazinane); and violuric acid(1,3-diazinane-2,4,5,6-tetrone-5-oxime).

Still further enhancing agents which may be applied in the invention include oximes of oxo- and formyl-derivatives of aromatic compounds, such as benzoquinone dioxime and salicylaldoxime (2-hydroxybenzaldehyde oxime), and N-hydroxyamides and N-hydroxyanilides, such as N-hydroxyacetanilide.

Preferred enhancing agents are selected from the group consisting of 1-hydroxybenzotriazole; 1-hydroxybenzotriazole hydrate; 1-hydroxybenzotriazole sodium salt; 1-hydroxybenzotriazole potassium salt; 1-hydroxybenzotriazole lithium salt; 1-hydroxybenzotriazole ammonium salt; 1-hydroxybenzotriazole calcium salt; 1-hydroxybenzotriazole magnesium salt; and 1-hydroxybenzotriazole-6-sulphonic acid.

A particularly preferred enhancing agent is 1-hydroxybenzotriazole.

All the specifications of N-hydroxy compounds above are understood to include tautomeric forms such as N-oxides whenever relevant.

Another preferred group of enhancing agents comprises a —CO—NOH— group and has the general formula III: 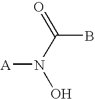
in which A is: 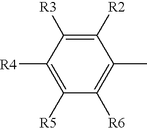
and B is the same as A; or B is H or C₁₋₁₂-alkyl, said alkyl may contain hydroxy, ester or ether groups (e.g. wherein the ether oxygen is directly attached to A-N(OH)C═O—, thus including N—hydroxy carbamic acid ester derivatives), and R2, R3, R4, R5 and R6 independently of each other are H, OH, NH₂, COOH, SO₃H, C₁₋₈-alkyl, acyl, NO₂, CN, Cl, Br, F, CF₃, NOH—CO-phenyl, CO—NOH-phenyl, C₁₋₆—CO—NOH-A, CO—NOH-A, COR12, phenyl-CO—NOH-A, OR7, NR8R9, COOR10, or NOH—CO—R11, wherein R7, R8, R9, R10, R 11 and R12 are C₁₋₁₂-alkyl or acyl.

R2, R3, R4, R5 and R6 of A are preferably H, OH, NH₂, COOH, SO₃H, C₁₋₃-alkyl, acyl, NO₂, CN, Cl, Br, F, CF₃, NOH—CO-phenyl, CO—NOH-phenyl, COR12, OR7, NR8R9, COOR10, or NOH—CO—R11, wherein R7, R8 and R9 are C₁₋₃-alkyl or acyl, and R10, R11 and R12 are C₁₋₃-alkyl; more preferably R2, R3, R4, R5 and R6 of A are H, OH, NH₂, COOH, SO₃H, CH₃, acyl, NO₂, CN, Cl, Br, F, CF₃, CO—NOH-phenyl, COCH₃, OR7, NR8R9, or COOCH₃, wherein R7, R8 and R9 are CH₃ or COCH₃; even more preferably R2, R3, R4, R5 and R6 of A are H, OH, COOH, SO₃H, CH₃, acyl, NO₂, CN, Cl, Br, F, CO—NOH-phenyl, OCH₃, COCH₃, or COOCH₃; and in particular R2, R3, R4, R5 and R6 of A are H, OH, COOH, SO₃H, CH₃, NO₂, CN, Cl, Br, CO—NOH-phenyl, or OCH₃.

R2, R3, R4, R5 and R6 of B are preferably H, OH, NH₂, COOH, SO₃H, C₁₋₃-alkyl, acyl, NO₂, CN, Cl, Br, F, CF₃, NOH—CO-phenyl, CO—NOH-phenyl, COR12, OR7, NR8R9, COOR10, or NOH—CO—R11, wherein R7, R8 and R9 are C₁₋₃-alkyl or acyl, and R10, R11 and R12 are C₁₋₃-alkyl; more preferably R2, R3, R4, R5 and R6 of B are H, OH, NH₂, COOH, SO₃H, CH₃, NO₂, CN, Cl, Br, F, CF₃, CO—NOH-phenyl, COCH₃, OR7, NR8R9, or COOCH₃, wherein R7, R8 and R9 are CH₃ or COCH₃; even more preferably R2, R3, R4, R5 and R6 of B are H, OH, COOH, SO₃H, CH₃, acyl, NO₂, CN, Cl, Br, F, CO—NOH-phenyl, OCH₃, COCH₃, or COOCH₃; and in particular R2, R3, R4, R5 and R6 of B are H, OH, COOH, SO₃H, CH₃, NO₂, CN, Cl, Br, CO—NOH-phenyl, or OCH₃.

B is preferably H or C₁₋₃-alkyl, said alkyl may contain hydroxy, ester or ether groups; preferably said alkyl may contain ester or ether groups; more preferably said alkyl may contain ether groups.

In an embodiment, A and B independently of each other are: 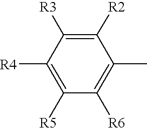
or B is H or C₁₋₃-alkyl, said alkyl may contain hydroxy, ester or ether groups (e.g. wherein the ether oxygen is directly attached to A-N(OH)C═O—, thus including N-hydroxy carbamic acid ester derivatives), and R2, R3, R4, R5 and R6 independently of each other are H, OH, NH₂, COOH, SO₃H, C₁₋₃-alkyl, acyl, NO₂, CN, Cl, Br, F, CF₃, NOH—CO-phenyl, CO—NOH-phenyl, COR12, OR7, NR8R9, COOR10, or NOH—CO—R11, wherein R7, R8 and R9 are C₁₋₃-alkyl or acyl, and R10, R11 and R12 are C₁₋₃-alkyl.

In another embodiment, A and B independently of each other are: 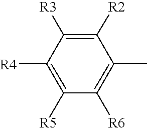
or B is H or C₁₋₃-alkyl, said alkyl may contain hydroxy or ether groups (e.g. wherein the ether oxygen is directly attached to A-N(OH)C═O—, thus including N-hydroxy carbamic acid ester derivatives), and R2, R3, R4, R5 and R6 independently of each other are H, OH, NH₂, COOH, SO₃H, CH₃, acyl, NO₂, CN, Cl, Br, F, CF₃, CO—NOH-phenyl, COCH₃, OR7, NR8R9, or COOCH₃, wherein R7, R8 and R9 are CH₃ or COCH₃.

In another embodiment, A and B independently of each other are: 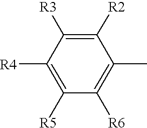
or B is H or C₁₋₃-alkyl, said alkyl may contain hydroxy or ether groups (e.g. wherein the ether oxygen is directly attached to A-N(OH)C═O—, thus including N-hydroxy carbamic acid ester derivatives), and R2, R3, R4, R5 and R6 independently of each other are H, OH, COOH, SO₃H, CH₃, acyl, NO₂, CN, Cl, Br, F, CO—NOH-phenyl, OCH₃, COCH₃, or COOCH₃.

In another embodiment, A and B independently of each other are: 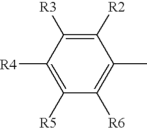
or B is C₁₋₃-alkyl, said alkyl may contain ether groups (e.g. wherein the ether oxygen is directly attached to A-N(OH)C═O—, thus including N-hydroxy carbamic acid ester derivatives), and R2, R3, R4, R5 and R6 independently of each other are H, OH, COOH, SO₃H, CH₃, NO₂, CN, Cl, Br, CO—NOH-phenyl, or OCH₃.

The terms “C₁₋ₙ-alkyl” wherein n can be from 2 through 12, as used herein, represent a branched or straight alkyl group having from one to the specified number of carbon atoms. Typical C₁₋₆-alkyl groups include, but are not limited to, methyl, ethyl, n-propyl, iso-propyl, butyl, iso-butyl, sec-butyl, tert-butyl, pentyl, iso-pentyl, hexyl, iso-hexyl and the like.

The term “acyl” as used herein refers to a monovalent substituent comprising a C₁₋₆-alkyl group linked through a carbonyl group; such as e.g. acetyl, propionyl, butyryl, isobutyryl, pivaloyl, valeryl, and the like.

In an embodiment at least one of the substituents R2, R3, R4, R5 and R6 of A are H, preferably at least two of the substituents R2, R3, R4, R5 and R6 of A are H, more preferably at least three of the substituents R2, R3, R4, R5 and R6 of A are H, most preferably at least four of the substituents R2, R3, R4, R5 and R6 of A are H, in particular all of R2, R3, R4, R5 and R6 of A are H.

In another embodiment at least one of the substituents R2, R3, R4, R5 and R6 of B are H, preferably at least two of the substituents R2, R3, R4, R5 and R6 of B are H, more preferably at least three of the substituents R2, R3, R4, R5 and R6 of B are H, most preferably at least four of the substituents R2, R3, R4, R5 and R6 of B are H, in particular all of R2, R3, R4, R5 and R6 of B are H.

In particular embodiments according to the invention the enhancing agent is selected from the group consisting of
4-nitrobenzoic acid-N-hydroxyanilide;
4-methoxybenzoic acid-N-hydroxyanilide;
N,N′-dihydroxy-N,N′-diphenylterephthalamide;
decanoic acid-N-hydroxyanilide;
N-hydroxy-4-cyanoacetanilide;
N-hydroxy-4-acetylacetanilide;
N-hydroxy-4-hydroxyacetanilide;
N-hydroxy-3-(N′-hydroxyacetamide)acetanilide;
4-cyanobenzoic acid-N-hydroxyanilide;
N-hydroxy-4-nitroacetanilide;
N-hydroxyacetanilide;
N-hydroxy-N-phenyl-carbamic acid isopropyl ester;
N-hydroxy-N-phenyl-carbamic acid methyl ester;
N-hydroxy-N-phenyl-carbamic acid phenyl ester;
N-hydroxy-N-phenyl-carbamic acid ethyl ester; and
N-hydroxy-N-(4-cyanophenyl)-carbamic acid methyl ester.

Another group of preferred enhancing agents is phenolic compounds (alkylsyringates) of the general formula IV: 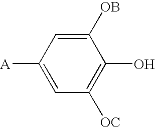
wherein the letter A in said formula denotes be a group such as -D, —CH═CH-D, —CH═CH—CH═CH-D, —CH═N-D, —N═N-D, or —N═CH-D, in which D is selected from the group consisting of —CO-E, —SO₂-E, —N—XY, and —N⁺—XYZ, in which E may be —H, —OH, —R, or —OR, and X and Y and Z may be identical or different and selected from —H and —R; R being a C₁-C₁₆ alkyl, preferably a C₁-C₈ alkyl. which alkyl may be saturated or unsaturated, branched or unbranched and optionally substituted with a carboxy, sulpho or amino group; and B and C may be the same or different and selected from CₘH₂ₘ₊₁, where m=1, 2, 3, 4 or 5.

In the above mentioned general formula IV, A may be placed meta to the hydroxy group instead of being placed in the para-position as shown.

In particular embodiments of the invention the enhancing agent is selected from the group having the general formula V: 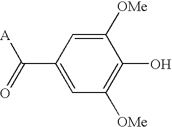
in which A is a group such as —H, —OH, —CH₃, —OCH₃, —O(CH₂)ₙCH₃, where n=1, 2, 3, 4, 5, 6, 7 or 8.

Yet another group of preferred enhancing agents are the compounds as described in general formula VI: 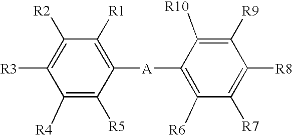
in which general formula A represents a single bond, or one of the following groups: (—CH₂—), (—CH═CH—), (—NR11-), (—CH═N—), (—N═N—), (—CH═N—N═CH—), or (>C═O);
and in which general formula the substituent groups R1-R11, which may be identical or different, independently represents any of the following radicals: hydrogen, halogen, hydroxy, formyl, acetyl, carboxy and esters and salts hereof, carbamoyl, sulfo and esters and salts hereof, sulfamoyl, methoxy, nitro, amino, phenyl, C₁₋₈-alkyl;
which carbamoyl, sulfamoyl, phenyl, and amino groups may furthermore be unsubstituted or substituted once or twice with a substituent group R12; and which C₁₋₈-alkyl group may be saturated or unsaturated, branched or unbranched, and may furthermore be unsubstituted or substituted with one or more substituent groups R12;
which substituent group R12 represents any of the following radicals: hydrogen, halogen, hydroxy, formyl, acetyl, carboxy and esters and salts hereof, carbamoyl, sulfo and esters and salts hereof, sulfamoyl, methoxy, nitro, amino, phenyl, or C₁₋₈-alkyl; which carbamoyl, sulfamoyl, and amino groups may furthermore be unsubstituted or substituted once or twice with hydroxy or methyl.
and in which general formula R5 and R6 may together form a group —B—, in which B represents a single bond, one of the following groups (—CH₂—), (—CH═CH—), (—CH═N—); or B represents sulfur, or oxygen.

In particular embodiments of the invention the enhancing agent is selected from the group having the general formula VIl: 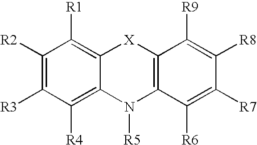
in which general formula X represents a single bond, oxygen, or sulphur;
and in which general formula the substituent groups R1-R9, which may be identical or different, independently represents any of the following radicals: hydrogen, halogen, hydroxy, formyl, acetyl, carboxy and esters and salts hereof, carbamoyl, sulfo and esters and salts hereof, sulfamoyl, methoxy, nitro, amino, phenyl, C₁₋₈-alkyl;
which carbamoyl, sulfamoyl, phenyl, and amino groups may furthermore be unsubstituted or substituted once or twice with a substituent group R10; and which C₁₋₈-alkyl group may be saturated or unsaturated, branched or unbranched, and may furthermore be unsubstituted or substituted with one or more substituent groups R10;
which substituent group R10 represents any of the following radicals: hydrogen, halogen, hydroxy, formyl, acetyl, carboxy and esters and salts hereof, carbamoyl, sulfo and esters and salts hereof, sulfamoyl, methoxy, nitro, amino, phenyl, or C₁₋₈-alkyl; which carbamoyl, sulfamoyl, and amino groups may furthermore be unsubstituted or substituted once or twice with hydroxy or methyl.

According to the invention, the enhancing agent may be present in the composition in a concentration in the range of from 0.01 mM to 1000 mM, preferably in the range of from 0.05 mM to 500 mM, more preferably in the range of from 0.1 mM to 100 mM, and most preferably in the range of from 0.1 mM to 50 mM.

Spores

The spores which are contacted with a laccase or a compound exhibiting laccase activity, a source of oxygen, a source of iodide ions and an enhancing agent in the method of the invention comprise all kinds of spores.

In an embodiment the spores are endospores, such as all Clostridium sp. spores, Brevibacillus sp. spores and Bacillus sp. spores, e.g. spores from Bacillus anthracis, Bacillus cereus, Bacillus mycoides, Bacillus thuringiensis, Bacillus subtilis, Bacillus putida, and Bacillus pumila.

In another embodiment the spores are exospores, such as Actinomycetales spores, e.g. spores from Actinomyces sp., Streptomyces sp., Thermoactinomyces sp., Saccharomonospora sp., and Saccharopylospora sp.

In another embodiment the spores are bacterial spores. Examples of bacterial spores include, but are not limited to, all Clostridium sp. spores and Bacillus sp. spores as mentioned above.

In yet another embodiment the spores are fungal spores. Examples of fungal spores include (in addition to those mentioned above), but are not limited to, conidiospores, such as spores from Aspergillus sp., and Penicillium sp.

Surfactants

The surfactants suitable for being incorporated in the sporocidal composition may be non-ionic (including semi-polar), anionic, cationic and/or zwitterionic. The surfactants are preferably anionic or non-ionic. The surfactants are typically present in the sporocidal composition at a concentration of from 0.01% to 10% by weight.

When included therein, the sporocidal composition will usually contain from about 0.01% to about 10%, preferably about 0.05% to about 5%, and more preferably about 0.1% to about 1% by weight of an anionic surfactant, such as linear alkylbenzenesulfonate, alpha-olefinsulfonate, alkyl sulfate (fatty alcohol sulfate), alcohol ethoxysulfate, secondary alkanesulfonate, alpha-sulfo fatty acid methyl ester, alkyl- or alkenylsuccinic acid or soap.

When included therein the sporocidal composition will usually contain from about 0.01% to about 10%, preferably about 0.05% to about 5%, and more preferably about 0.1% to about 1% by weight of a non-ionic surfactant, such as alcohol ethoxylate, nonylphenol ethoxylate, alkylpolyglycoside, alkyldimethylamineoxide, ethoxylated fatty acid monoethanolamide, fatty acid monoethanolamide, polyhydroxy alkyl fatty acid amide, or N-acyl N-alkyl derivatives of glucosamine (“glucamides”).

Compositions

The present invention provides a composition comprising a laccase or a compound exhibiting laccase activity, a source of oxygen, a source of iodide ions and an enhancing agent.

The laccase or the compound exhibiting laccase activity, the source of iodide ions and the enhancing agent may be formulated as a liquid (e.g. aqueous), a solid, a gel, a paste or a dry product formulation. The dry product formulation may subsequently be re-hydrated to form an active liquid or semi-liquid formulation usable in the method of the invention.

When the laccase or the compound exhibiting laccase activity, the source of iodide ions and the enhancing agent are formulated as a dry formulation, the components may be mixed, arranged in discrete layers or packaged separately.

When formulated as a solid, all components may be mixed together, e.g., as a powder, a granulate or a gelled product.

When other than dry form compositions are used and even in that case, it is preferred to use a two-part formulation system having the enzyme(s) separate from the rest of the composition.

The composition of the invention may further comprise auxiliary agents such as wetting agents, thickening agents, buffer, stabilisers, perfume, colourants, fillers and the like.

Useful wetting agents are surfactants, i.e. non-ionic, anionic, amphoteric or zwitterionic surfactants. Surfactants are further described above.

The composition of the invention may be a concentrated product or a ready-to-use product. In use, the concentrated product is typically diluted with water to provide a medium having an effective sporocidal activity, applied to the object to be cleaned or disinfected, and allowed to react with the spores present.

The pH of an aqueous solution of the composition is in the range of from pH 2 to 11, preferably in the range of from pH 3 to 10.5, more preferably in the range of from pH 4 to 10, most preferably in the range of from pH 5 to 9, and in particular in the range of from pH 6 to 8.

Methods and Uses

The present invention provides an enzymatic method for killing or inactivating spores, comprising contacting the spores with a laccase or a compound exhibiting laccase activity, a source of oxygen, a source of iodide ions and an enhancing agent.

In the context of the present invention the term “killing or inactivating spores” is intended to mean that at least 99% of the spores are not capable of transforming (germinating) into vegetative cells. Preferably 99.9% (more preferably 99.99% and most preferably 99.999%) of the spores are not capable of transforming into vegetative cells.

The spores May be contacted by the composition of the invention at a temperature between 0 and 90 degrees Celsius, preferably between 5 and 80 degrees Celsius, more preferably between 10 and 70 degrees Celsius, even more preferably between 15 and 60 degrees Celsius, most preferably between 18 and 50 degrees Celsius, and in particular between 20 and 40 degrees Celsius.

The composition of the invention is suitable for killing or inactivating spores in a variety of environments. The composition of the invention may desirably be used in any environment to reduce spore contamination, such as the health-care industry (e.g. animal hospitals, human hospitals, animal clinics, human clinics, nursing homes, day-care facilities for children or senior citizens, etc.), the food industry (e.g. restaurants, food-processing plants, food-storage plants, grocery stores, etc.), the hospitality industry (e.g. hotels, motels, resorts, cruise ships, etc.), the education industry (e.g. schools and universities), etc.

The composition of the invention may desirably be used in any environment to reduce spore contamination, such as general-premise surfaces (e.g. floors, walls, ceilings, exterior of furniture, etc.), specific-equipment surfaces (e.g. hard surfaces, manufacturing equipment, processing equipment, etc.), textiles (e.g. cottons, wools, silks, synthetic fabrics such as polyesters, polyolefins, and acrylics, fiber blends such as cottonpolyester, etc.), wood and cellulose-based systems (e.g. paper), soil, animal carcasses (e.g. hide, meat, hair, feathers, etc.), foodstuffs (e.g. fruits, vegetables, nuts, meats, etc.), and water.

In one embodiment, the method of the invention is directed to sporocidal treatment of textiles. Spores of the Bacillus cereus group have been identified as the predominant postlaundering contaminant of textiles. Thus, the treatment of textiles with a composition of the invention is particularly useful for sporocidal activity against the contaminants of textiles.

Examples of textiles that can be treated with the composition of the invention include, but are not limited to, personal items (e.g. shirts, pants, stockings, undergarments, etc.), institutional items (e.g. towels, lab coats, gowns, aprons, etc.), hospitality items (e.g. towels, napkins, tablecloths, etc.).

A sporocidal treatment of textiles with a composition of the invention may include contacting a textile with a composition of the invention. This contacting can occur prior to laundering the textile. Alternatively, this contacting can occur during laundering of the textile to provide sporocidal activity and optionally provide cleansing activity to remove or reduce soils, stains, etc. from the textile.

The spores which are contacted by the composition of the invention may be situated on any surface including, but not limited to, a surface of a process equipment used in e.g. a dairy, a chemical or pharmaceutical process plant, a piece of laboratory equipment, a water sanitation system, an oil processing plant, a paper pulp processing plant, a water treatment plant, or a cooling tower. The composition of the invention should be used in an amount, which is effective for killing or inactivating the spores on the surface in question.

The spores may be contacted with the composition of the invention by submerging the spores in an aqueous formulation of the composition (e.g. a laundering process), by spraying the composition onto the spores, by applying the composition to the spores by means of a cloth, or by any other method recognized by the skilled person. Any method of applying the composition of the invention to the spores, which results in killing or inactivating the spores, is an acceptable method of application.

The method of the invention is also useful for decontamination of locations which have been exposed to spores (e.g. pathogenic spores), such as biological warfare agents, e.g. spores of Bacillus anthrasis capable of causing anthrax. Such locations include, but are not limited to, clothings (such as army clothings), inner and outer parts of vehicles, inner and outer parts of buildings, any kind of army facility, and any kind of environment mentioned above.

The present invention is further described by the following examples which should not be construed as limiting the scope of the invention.

### EXAMPLES

Chemicals used as buffers and substrates were commercial products of at least reagent grade.

### Example 1

Production of Spores

A Tryptose Blod Agar Base (TBAB) plate was streaked from a fresh culture of Bacillus thuringiensis (B. thuringiensis type strain ATCC10792). The culture was incubated overnight at 30 degrees Celsius.

A loopfull of pure B. thuringiensis cells from the TBAB plate was suspended in 2 ml of sterile water. 2×SG plates were each inoculated with 100 microliter of the cell suspension. The composition of 2×SG was as follows: 16 g/L Difco Bacto Nutrient Broth, 0.5 MgSO₄×7H₂O, 2.0 g/L KCl, 1.0 ml/100 ml of 10% glucose, 0.1 ml/100 ml of 1 M Ca(NO₃)₂, 0.1 ml/100 ml of 0.1 M MnSO₄, 10 microliter/100 ml of 0.01 M FeSO₄, and 1% Difco Bacto Agar.

Plates were incubated for 48-72 hrs. at 30 degrees Celsius. Sporulation was checked with phase-contrast microscopy. Spores are phase-bright.

When sporulation efficiency was close to 100%, the cell lawn was harvested with water and the cells were suspended by intensive vortexing. Cells were collected by-centrifugation for 5-10 minutes at 6000 G at 4 degrees Celsius, and washed 3 times with ice cold water. The pellet contained vegetative cells and spores.

A step-density gradient was applied for separation of the spores from the vegetative cells. A centrifuge tube containing 30 ml 43% Urographin® was prepared for each washed pellet. 3 ml of cell spore mixture in Urographin was prepared so that the final Urographin concentration was 20%. The 20% Urographin cell/spore mixture was gently loaded onto the top layer of the centrifuge tubes containing 43% Urographin.

The centrifuge tubes were centrifuged at 10000 G at room temperature for 30 minutes. The supernatant was gently removed. The pure spore pellet was suspended in 1 ml ice-cold water and transfered to a microfuge tube. Centrifugation was continued at maximum speed for 1-2 min at 4 degrees Celsius, and the pellet was washed in ice-cold water 2 more times.

The purity and number of spores/ml was checked by phase contrast microscopy and a haemocytometer. The spores were stored suspended in water at minus 20 degrees Celsius.

Bacillus globigii spores were produced by following the same procedure as outlined above.

### Example 2

Killing of Spores

The following reagents were prepared:
DMG buffer (3,3-DiMethylGlutaric acid, Sigma D4379), 50 mM, pH adjusted to 6.5 with NaOH;
Bacillus thuringiensis spores were re-suspended in DMG buffer to a density of 2×10⁹ spores per ml;
Myceliophthora thermophila laccase (as disclosed in WO 95/33836, SEQ ID NO:1; and available from Novozymes ANS) was diluted to 200 microgram per ml in DMG buffer;
Polyporus pinsitus laccase (as disclosed in WO 96/00290, FIG. 1, SEQ ID NO:1; and available from Novozymes ANS) was diluted to 200 microgram per ml in DMG buffer;
200 mM Potassium iodide (KI) solution in water;
1 mM Methylsyringate (methyl 3,5-dimethoxy4-hydroxybenzoate, Sigma S40,944-8) solution in ethanol/DMG buffer (1:1);
3 mM MTT (3-(4,5-Dimethylthiazol-yl)-2,5-diphenyltetrazolium bromide, Sigma M2128) solution in water.

TBB growth medium:
10 g/l Tryptose,
3 g/l Beef Extract,
5 g/l NaCl,
water ad 1000 ml
final pH 7.2+/−0.2.

Spore suspension was pipetted into the wells in row A of a microtiter plate. The other reagents were added as indicated in table 1 below. The reaction was initiated by the addition of laccase solution.

TABLE 1

| | DMG buffer | Spores | Laccase | KI | Methyl- |
|---|---|---|---|---|---|
| | (micro- | (micro- | (micro- | (micro- | syringate |
| Wells | liter) | liter) | liter) | liter) | (microliter) |
| A1-A2 | 115 | 50 | 20 | 5 | 10 |
| A3-A4 | 120 | 50 | 20 | 0 | 10 |
| A5-A6 | 125 | 50 | 20 | 5 | 0 |
| A7-A8 | 145 | 50 | 0 | 5 | 0 |
| A9-A10 | 130 | 50 | 20 | 0 | 0 |
| A11-A12 | 150 | 50 | 0 | 0 | 0 |

The microtiter plate was incubated at room temperature (24 degrees Celsius) for 1 hour. 180 microliter TBB growth medium was added to all wells in rows B to H of the microtiter plate. Serial 10 fold dilutions were made by pipetting 20 microliter from row A to row B, and then from row B to row C, and then from row C to row D, and so on until row H.

The microtiter plate was incubated at 30 degrees Celsius for 20-24 hours to allow spores to germinate and grow. Growth was evaluated by a microplate reader and visually by “developing the growth” by addition of 5 microliter 3 mM MTT to each well. Formation of purple formazans reveals bacterial growth and thus the degree of spore inactivation. In the tables growth is indicated with a “+” symbol.

TABLE 2
Results of evaluation of growth for spores treated
with Myceliophthora thermophila laccase.

| | 1 | 2 | 3 | 4 | 5 | 6 | 7 | 8 | 9 | 10 | 11 | 12 |
|---|---|---|---|---|---|---|---|---|---|---|---|---|
| A | | | | | | | | | | | | |
| B | − | − | + | + | + | + | + | + | + | + | − | + |
| C | − | − | + | + | + | + | + | + | + | + | + | + |
| D | − | − | + | + | + | + | + | + | + | + | − | + |
| E | − | − | + | + | + | + | + | + | + | + | − | + |
| F | − | − | + | + | + | + | + | + | + | + | − | + |
| G | − | − | + | + | + | + | + | + | + | + | − | + |
| H | − | − | − | − | − | − | − | − | + | + | − | − |

TABLE 3
Results of evaluation of growth for spores
treated with Polyporus pinsitus laccase.

| | 1 | 2 | 3 | 4 | 5 | 6 | 7 | 8 | 9 | 10 | 11 | 12 |
|---|---|---|---|---|---|---|---|---|---|---|---|---|
| A | | | | | | | | | | | | |
| B | − | − | + | + | + | + | + | + | + | + | + | + |
| C | − | − | + | + | + | + | + | + | + | + | + | + |
| D | − | − | + | + | + | + | + | + | + | + | + | + |
| E | − | − | + | + | + | + | + | + | + | + | + | + |
| F | − | − | + | + | + | + | + | + | + | + | + | + |
| G | − | − | + | − | + | + | + | + | + | + | + | + |
| H | − | − | − | − | − | − | + | − | + | + | − | + |

The results in Tables 2 and 3 show that only the formulation added to wells A1-A2 including both laccase, potassium iodide and enhancing agent (methylsyringate) is capable of inactivating the spores.

### Example 3

Killing of Spores at 5-60 Degrees Celsius

The following reagents were prepared:
DMG buffer (3,3-DiMethylGlutaric acid, Sigma D4379), 50 mM, pH adjusted to 6.5 with NaOH;
Bacillus thuringiensis spores were re-suspended in DMG buffer to a density of 2×10⁹ spores per ml;
Myceliophthora thermnophila laccase (as disclosed in WO 95/33836, SEQ ID NO:1; and available from Novozymes A/S) was diluted to 500 microgram per ml in DMG buffer;
Coprinus cinereus laccase (as disclosed in WO 97/08325, FIG. 1, SEQ ID NO:27; and available from Novozymes A/S) was diluted to 500 microgram per ml in DMG buffer;
Rhizoctonia solanii laccase (as disclosed in WO 95/07988, FIG. 4, SEQ ID NO:14; and available from Novozymes A/S) was diluted to 500 microgram per ml in DMG buffer;
Polyporus pinsitus laccase (as disclosed in WO 96/00290, FIG. 1, SEQ ID NO:1; and available from Novozymes A/S) was diluted to 500 microgram per ml in DMG buffer;
200 mM Potassium iodide (KI) solution in water;
1 mM Methylsyringate (methyl 3,5-dimethoxy-4-hydroxybenzoate, Sigma S40,944-8) solution in ethanol/DMG buffer (1:1);
3 mM MTT (3-(4,5-Dimethylthiazol-yl)-2,5-diphenyltetrazolium bromide, Sigma M2128) solution in water.

TBB growth medium:
10 g/l Tryptose,
3 g/l Beef Extract,
5 g/l NaCl,
water ad 1000 ml
final pH 7.2±0.2.

Spore suspension was pipetted into the wells in row A of all microtiter plates. The other reagents were added as indicated in table 4 below. The reaction was initiated by the addition of laccase solution. The microtiter plates were then incubated at the specified temperature for 1 hour.

180 microliter TBB growth medium was added to all wells in rows B to H of the microtiter plates.

Serial 10 fold dilutions were made by pipetting 20 microliter from row A to row B, and then from row B to row C, and then from row C to row D, and so on until row H.

TABLE 4
Microtiter plate setup - each plate was used
to test two laccases at one temperature.

| | DMG buffer | Spores | Laccase | KI | Methyl- |
|---|---|---|---|---|---|
| | (micro- | (micro- | (micro- | (micro- | syringate |
| Wells | liter) | liter) | liter) | liter) | (microliter) |
| A1-A3 | 166 | 50 | 15 | 6.25 | 12.5 |
| A4-A6 | 200 | 50 | 0 | 0 | 0 |
| A7-A9 | 166 | 50 | 15 | 6.25 | 12.5 |
| A10-A12 | 200 | 50 | 0 | 0 | 0 |

The microtiter plates were incubated at 30 degrees Celsius for 20-24 hours to allow spores to germinate and grow. Growth was evaluated by a microplate reader and visually by “developing the growth” by addition of 5 microliter 3 mM MTT to each well. Formation of purple formazans reveals bacterial growth and thus the degree of spore inactivation. The sporocidal potential was calculated as the difference of the number of dilution steps with bacterial growth between the control and the laccase/iodide/methylsyringate containing wells. The sporocidal potential is measured in log units (log U)—one log unit equals a difference in growth of one 10-fold dilution step as described in Example 2.

The results from testing the four laccases at 5, 10, 15, 20, 25, 30, 35, 40, 45, 50, 55 and 60 degrees Celsius are summarised in tables 5, 6, 7 and 8.

TABLE 5
Sporocidal effect of Coprinus cinereus laccase at 5-60 degrees Celsius.

| | | | | | | | | | | | | |
|---|---|---|---|---|---|---|---|---|---|---|---|---|
| Temperature | 5 | 10 | 15 | 20 | 25 | 30 | 35 | 40 | 45 | 50 | 55 | 60 |
| (degrees Celsius) | | | | | | | | | | | | |
| Kill, log U | 1 | 1 | 1 | 4 | 4.5 | 4 | 4 | 4.5 | 4 | 3.5 | 3.5 | 2 |

TABLE 6
Sporocidal effect of Myceliophthora thermophila laccase
at 5-60 degrees Celsius.

| | | | | | | | | | | | | |
|---|---|---|---|---|---|---|---|---|---|---|---|---|
| Temperature | 5 | 10 | 15 | 20 | 25 | 30 | 35 | 40 | 45 | 50 | 55 | 60 |
| (degrees Celsius) | | | | | | | | | | | | |
| Kill, log U | 0 | 3 | 3 | 3 | 5 | 5.5 | 5 | 5 | 5 | 3.5 | 3 | 3 |

TABLE 7
Sporocidal effect of Polyporus pinsitus laccase at 5-60 degrees Celsius.

| | | | | | | | | | | | | |
|---|---|---|---|---|---|---|---|---|---|---|---|---|
| Temperature | 5 | 10 | 15 | 20 | 25 | 30 | 35 | 40 | 45 | 50 | 55 | 60 |
| (degrees Celsius) | | | | | | | | | | | | |
| Kill, log U | 3 | 3.5 | 6 | 6.5 | 7 | 7 | 7 | 7 | 6 | 6 | 5 | 5 |

TABLE 8
Sporocidal effect of Rhizoctonia solanii laccase at 5-60 degrees Celsius.

| | | | | | | | | | | | | |
|---|---|---|---|---|---|---|---|---|---|---|---|---|
| Temperature | 5 | 10 | 15 | 20 | 25 | 30 | 35 | 40 | 45 | 50 | 55 | 60 |
| (degrees Celsius) | | | | | | | | | | | | |
| Kill, log U | 1 | 1.5 | 3 | 3 | 3 | 3 | 3 | 3 | 2 | 2 | 2 | 2 |

The results shown in tables 5-8 indicate that all four laccases exhibit sporocidal activity and that the optimal sporocidal effect is delivered in the temperature range 15-45 degrees Celsius.

### Example 4

Killing of Spores at pH 6.0-pH8.0

The following reagents were prepared:
DMG buffers (3,3-DiMethylGlutaric acid, Sigma D4379), 50 mM, pH adjusted to 6.0, 6.5, 7.0, 7.5 and 8.0 with NaOH;
Bacillus thuringiensis spores were re-suspended in DMG buffer to a density of 2×10⁹ spores per ml;
Myceliophthora thermophila laccase (as disclosed in WO 95/33836, SEQ ID NO:1; and available from Novozymes A/S) was diluted to 500 microgram per ml in DMG buffer;
Coptinus cinereus laccase (as disclosed in WO 97/08325, FIG. 1, SEQ ID NO:27; and available from Novozymes A/S) was diluted to 500 microgram per ml in DMG buffer;
Rhizoctonia solanii laccase (as disclosed in WO 95/07988, FIG. 4, SEQ ID NO:14; and available from Novozymes A/S) was diluted to 500 microgram per ml in DMG buffer;
Polyporus pinsitus laccase (as disclosed in WO 96/00290, FIG. 1, SEQ ID NO:1; and available from Novozymes A/S) was diluted to 500 microgram per ml in DMG buffer;
200 mM Potassium iodide (KI) solution in water;
1 mM Methylsyringate (methyl 3,5-dimethoxy4-hydroxybenzoate, Sigma S40,944-8) solution in ethanol/DMG buffer (1:1);
3 mM MTT (3-(4,5-Dimethylthiazol-yl)-2,5-diphenyltetrazolium bromide, Sigma M2128) solution in water.

TBB growth medium:
10 g/l Tryptose,
3 g/l Beef Extract,
5 g/l NaCl,
water ad 1000 ml
final pH 7.2±0.2.

Spore suspension was pipetted into the wells in row A of a microtiter plate. The other reagents were added as indicated in table 9 below. The reaction was initiated by the addition of laccase solution. The microtiter plate was then incubated at 30 degrees Celsius for 1 hour.

180 microliter TBB growth medium was added to all wells in rows B to H of the microtiter plate. Serial 10 fold dilutions were made by pipetting 20 microliter from row A to row B, and then from row B to row C, and then from row C to row D, and so on until row H.

TABLE 9
A microtiterplate was set up for each
of the four laccases at each pH value.

| | DMG buffer | Spores | Laccase | KI | Methyl- |
|---|---|---|---|---|---|
| | (micro- | (micro- | (micro- | (micro- | syringate |
| Wells | liter) | liter) | liter) | liter) | (microliter) |
| A1-A2 | 182 | 50 | 5 | 6.5 | 6.5 |
| A3-A4 | 165.5 | 50 | 15 | 6.5 | 13 |
| A5-A6 | 188.5 | 50 | 5 | 6.5 | 0 |
| A7-A8 | 188.5 | 50 | 5 | 0 | 6.5 |
| A9-A10 | 187 | 50 | 0 | 6.5 | 6.5 |
| A11-A12 | 200 | 50 | 0 | 0 | 0 |

The microtiter plate was incubated at 30 degrees Celsius for 20-24 hours to allow spores to germinate and grow. Growth was evaluated by a microplate reader and visually by “developing the growth” by addition of 5 microliter 3 mM MTT to each well. Formation of purple formazans reveals bacterial growth and thus the degree of spore inactivation. The sporocidal potential was calculated as the difference of the number of dilution steps (with bacterial growth) between the control and the laccase/iodide/methylsyringate containing wells. The sporocidal potential is measured in log units (log U)—one log unit equals a difference in growth of one 10-fold dilution step. The results from testing the four laccases at pH 6.0—pH 8.0 are summarised in tables 10, 11, 12 and 13.

TABLE 10
Sporocidal effect of Coprinus cinereus laccase
in the pH range pH 6.0-8.0

| | | | | | |
|---|---|---|---|---|---|
| PH | 6.0 | 6.5 | 7.0 | 7.5 | 8.0 |
| Kill, log U | 5 | 4.5 | 3.5 | 3.5 | 2 |

TABLE 11
Sporocidal effect of Myceliophthora thermophila laccase
in the pH range pH 6.0-8.0

| | | | | | |
|---|---|---|---|---|---|
| pH | 6.0 | 6.5 | 7.0 | 7.5 | 8.0 |
| Kill, log U | 6 | 4 | 4.5 | 2.5 | 2 |

TABLE 12
Sporocidal effect of Polyporus pinsitus laccase
in the pH range pH 6.0-8.0

| | | | | | |
|---|---|---|---|---|---|
| pH | 6.0 | 6.5 | 7.0 | 7.5 | 8.0 |
| Kill, log U | 7 | 7 | 5.5 | 3 | 0 |

TABLE 13
Sporocidal effect of Rhizoctonia solanii laccase
in the pH range pH 6.0-8.0.

| | | | | | |
|---|---|---|---|---|---|
| pH | 6.0 | 6.5 | 7.0 | 7.5 | 8.0 |
| Kill, log U | 3.5 | 3 | 3 | 2 | 0.5 |

The results in tables 10-13 demonstrate that all 4 laccases are active in the specified pH range.

### Example 5

Killing of Spores Deposited on Ceramic Tiles I

The following reagents were prepared:
DMG buffer (3,3-DiMethylGlutaric acid, Sigma D4379), 50 mM, pH adjusted to 6.5 with NaOH;
Bacillus thuringiensis spores were re-suspended in DMG buffer to a density of 2×10⁹ spores per ml;
Myceliophthora thermophila laccase (as disclosed in WO 95/33836, SEQ ID NO:1; and available from Novozymes A/S) was diluted to 30 mg/ml.
200 mM Potassium iodide (KI) solution in water;
10 mM Methylsyringate (methyl 3,5-dimethoxy-4-hydroxybenzoate, Sigma S40,944-8) solution in ethanol/DMG buffer (1:1);
3 mM MTT (3-(4,5-Dimethylthiazol-yl)-2,5-diphenyltetrazolium bromide, Sigma M2128) solution in water.

TBB growth medium with agarose:
10 g/l Tryptose,
3 g/l Beef Extract,
5 g/l NaCl,
5 g/l Agarose
water ad 1000 ml
final pH 7.2+/−0.2.

Spores were diluted to 20 spores/ml; 200 spores/ml; 2000 spores/ml; 20,000 spores/ml and 200,000 spores/ml in water.

1 ml spore suspension was spread on glazed and unglazed faces of 5×5 cm ceramic tiles and the tiles were allowed to dry overnight at room temperature.

Tiles, each with 20; 200; 2000; 20,000 and 200,000 spores/tile were placed both the glazed side up or with the unglazed side up in 9 cm petri dishes.

The following reagents were mixed:
222 microliter Myceliophthora thermophila laccase solution
702 microliter Potassium iodide solution
222 microliter methylsyringate solution
2769 microliter 1,2-propanediol
26586 microliter DMG buffer, pH 6.5 —and 1400 microliter of this mixture was pipetted onto the surface of each tile and gently spread to cover the tile from corner to corner with the pipette tip. As a control, the spore inoculated tiles were treated with 1400 microliter of the control substance: 3 ml 1,2-propanediol mixed with 29 ml DMG buffer pH 6.5.

The tiles were allowed to incubate, uncovered, at room temperature (approx. 24 degrees Celsius) over night. The surface of each dry tile was covered by a thin layer of molten (approx. 45 degrees Celsius) TBB growth medium with agarose. When the agarose growth medium had solidified, the tiles were incubated in a moist chamber at 30 degrees Celsius for approx. 20 hours. Following incubation, microcolonies were revealed by adding 3 mM MTT, drop by drop, until the agarose surface of the tile was covered. After ½-2 hours live micro-colonies were seen as purple spots. In table 14 the results from a comparison of the treated tiles with control tiles are shown.

TABLE 14
Decontamination of ceramic tiles seeded with Bacillus thuringiensis spores
with laccase-iodide-enhancer solution.

| Glazed face | | | Unglazed face | | |
|---|---|---|---|---|---|
| No. of spores | No. of spores germinated | | No. of spores | No. of spores germinated | |
| deposited | Control | Treated | deposited | Control | Treated |
| 20 | approx. 20 | 0 | 20 | approx. 20 | 0 |
| 200 | approx. 200 | 0 | 200 | approx. 200 | 0 |
| 2000 | too many to | 0 | 2000 | too many to | 0 |
| | count | | | count | |
| 20.000 | too many to | 0 | 20.000 | too many to | 0 |
| | count | | | count | |
| 200.000 | too many to | 5 | 200.000 | too many to | 14 |
| | count | | | count | |

The results demonstrate that spores deposited on surfaces are inactivated by the laccase system. The density of the surface deposited spores was approx. 4×10⁷/m².

### Example 6

Killing of Spores Deposited on Ceramic Tiles II

The following reagents were prepared:
DMG buffer (3,3-DiMethylGlutaric acid, Sigma D4379), 50 mM, pH adjusted to 6.5 with NaOH;
Bacillus thuringiensis spores were re-suspended in DMG buffer to a density of 2×10⁹ spores per ml;
Myceliophthora thermophila laccase (as disclosed in WO 95/33836, SEQ ID NO:1; and available from Novozymes A/S) was diluted to 30 mg/ml.
Polyporus pinsitus laccase (as disclosed in WO 96/00290, FIG. 1, SEQ ID NO:1; and available from Novozymes A/S) was diluted to 7.5 mg/ml.
200 mM Potassium iodide (KI) solution in water.
10 mM Methylsyringate (methyl 3,5-dimethoxy-4-hydroxybenzoate, Sigma S40,944-8) solution in ethanol/DMG buffer (1:1);
3 mM MTT (3-(4,5-Dimethylthiazol-yl)-2,5-diphenyltetrazolium bromide, Sigma M2128) solution in water.

TBB growth medium with agarose:
10 g/l Tryptose,
3 g/l Beef Extract,
5 g/l NaCl,
5 g/l Agarose
water ad 1000 ml
final pH 7.2+/−0.2.

Spores were diluted to approximately 5×10⁶ spores/ml in water.

1 ml spore suspension was spread on each glazed and unglazed face of 5×5 cm ceramic tiles, and the tiles were allowed to dry overnight at room temperature.

The tiles were arranged with the spore impregnated side up in 9 cm petri dishes.

Mixtures A, B, C and D were prepared by adding together the following reagents:

A
5 microliter Myceliopthora thermophila laccase solution
70 microliter Potassium iodide solution
25 microliter methylsyringate solution
270 microliter 1,2-propanediol
2600 microliter DMG buffer, pH 6.5
yielding a mixture with 50 microgramme/ml Myceliopthora thermophila laccase.

B
2.5 microliter Myceliopthora thermophila laccase solution
70 microliter Potassium iodide solution
25 microliter methylsyringate solution ‘270 microliter 1,2-propanediol
2600 microliter DMG buffer, pH 6.5
yielding a mixture with 25 microgramme/ml Myceliopthora thermophila laccase.

C
20 microliter Polyporus pinsitus laccase solution
70 microliter Potassium iodide solution
25 microliter methylsyringate solution
270 microliter 1,2-propanediol
2600 microliter DMG buffer, pH 6.5
yielding a mixture with 50 microgramme/ml Polyporus pinsitus laccase.

D
10 microliter Polyporus pinsitus laccase solution
70 microliter Potassium iodide solution
25 microliter methylsyringate solution
270 microliter 1,2-propanediol
2600 microliter DMG buffer, pH 6.5
yielding a mixture with 25 microgramme/ml Polyporus pinsitus laccase.

1400 microliter of the above-mentioned mixtures A, B, C or D were pipetted onto the surfaces of the tiles and gently spread to cover the tile from corner to corner with the pipette tip.

As a control, the spore inoculated tiles were treated with 1400 microliter of the control substance: 270 microliter 1,2-propanediol mixed with 2700 microliter DMG buffer pH 6.5.

The tiles were allowed to incubate, uncovered, at room temperature (approx. 21 degrees Celsius) over night. The surface of each dry tile was covered by a thin layer of molten (approx. 45 degrees Celsius) TBB growth medium with agarose. When the agarose growth medium had solidified, the tiles were incubated in a moist chamber at 30 degrees Celsius for approx. 20 hours. Following incubation, microcolonies were revealed by adding 3 mM MTT, drop by drop, until the agarose surface of the tile was covered. After ½-2 hours live micro-colonies were seen as purple spots. In table 15 the results from a comparison of the treated tiles with control tiles are shown.

TABLE 15
Decontamination of ceramic tiles seeded with Bacillus thuringiensis spores
with laccase-iodide-enhancer solution with decreasing amounts of laccase

| | Mixture A | Mixture B | Mixture C | Mixture D | Control |
|---|---|---|---|---|---|
| Face of | (Number of | (Number of | (Number of | (Number of | (Number of |
| ceramic tile | colonies) | colonies) | colonies) | colonies) | colonies) |
| Glazed face | 10 | 11 | 0 | 1 | too many to |
| | | | | | count |
| Unglazed | 24 | approx. 100 | 2 | 4 | too many to |
| face | | | | | count |

The results demonstrate that spores deposited on surfaces are inactivated by laccase decontamination systems with low (less than 50 mg/l) laccase concentrations.

### Example 7

Killing of Spores Deposited on Textile

The following reagents were prepared:
Spores were re-suspended in sterile water to a density of 6×10⁸/ml.
DMG buffer (3,3-DiMethylGlutaric acid, Sigma D4379), 50 mM, pH adjusted to 6.5 with NaOH;
DMG buffer (3,3-DiMethylGlutaric acid, Sigma D4379), 50 mM, pH adjusted to 6.0 with NaOH;
Myceliophthora thermophila laccase (as disclosed in WO 95/33836, SEQ ID NO:1; and available from Novozymes A/S) was diluted to 30 milligram per ml in DMG buffer;
200 mM Potassium iodide (KI) solution in water;
10 mM Methylsyringate (methyl 3,5-dimethoxy-4-hydroxybenzoate, Sigma S40,944-8) solution in Ethanol/DMG buffer (1:1);
0.1% (v/v) Tween
3 mM MTT (3-(4,5-Dimethylthiazol-yl)-2,5-diphenyltetrazolium bromide, Sigma M2128) solution in water.

TBB growth medium:
10 g/l Tryptose,
3 g/l Beef Extract,
5 g/l NaCl,
water ad 1000 ml
final pH 7.2+/−0.2.

Laccase-iodide-enhancer solution:
37 microliter Myceliopthora thermophila laccase solution
115 microliter Potassium iodide solution
37 microliter methylsyringate solution
500 microliter 1,2-propanediol
4311 microliter DMG buffer, pH 6.0

100 microliter of the spore suspension was pipetted onto three dry Pro-shot Gun cleaning cotton patches, 1⅛″×1⅛″. The patches (patch 1, patch 2 and control) were allowed to dry overnight at room temperature.

Each of patch 1 and patch 2 were placed in a 5 cm open Petri dish and 2 ml of the laccase-iodide-enhancer solution was poured onto the patch and the open Petri dish with the patch was allowed to incubate at room temperature (approx. 24 degrees Celsius) for 24 hours. A patch (control) treated with a 500 microliter 1,2-propanediol in 4500 microliter DMG buffer pH 6.5 was used as a control.

The almost-dry patches were transferred to 50 ml screwcapped disposable centrifuge tubes containing 10 ml 0.1% (v/v) Tween. The tubes were immersed in an ultrasound (Branson) cleaning bath for 30 minutes at room temperature.

100 microliter of the fluid from the ultrasound treated centrifuge tubes were pipetted to wells in row A in a microtiter plate according to table 16.

TABLE 16
Microtiter plate setup.

| | Laccase-iodide- | Laccase-iodide- | |
|---|---|---|---|
| | enhancer | enhancer | |
| | Patch 1 | Patch 2 | Control |
| Wells | (microliter) | (microliter) | (microliter) |
| A1-A4 | 100 | 0 | 0 |
| A5-A8 | 0 | 100 | 0 |
| A9-12 | 0 | 0 | 100 |

180 microliter TBB growth medium was added to all wells in rows B to H of the microtiter plate. Serial 10 fold dilutions were made by pipetting 20 microliter from row A to row B, and then from row B to row C, and then from row C to row D, and so on until row H. Then 150 microliter TBB was pipetted into the wells in row A

The microtiter plate was incubated at 30 degrees Celsius for 12-24 hours to allow spores to germinate and grow. Growth was evaluated by a microplate reader and visually by “developing the growth” by addition of 5 microliter 3 mM MTT to each well. Formation of purple formazans reveals bacterial growth and thus the degree of spore inactivation.

TABLE 17
Results of evaluation of growth.

| | 1 | 2 | 3 | 4 | 5 | 6 | 7 | 8 | 9 | 10 | 11 | 12 |
|---|---|---|---|---|---|---|---|---|---|---|---|---|
| A | − | − | − | − | − | − | − | − | + | + | + | + |
| B | + | + | + | + | − | − | − | − | + | + | + | + |
| C | − | − | − | − | − | − | − | − | + | + | + | + |
| D | − | − | − | − | − | − | − | − | + | + | + | + |
| E | − | − | − | − | − | − | − | − | + | + | − | − |
| F | − | − | − | − | − | − | − | − | − | − | + | + |
| G | − | − | − | − | − | − | − | − | − | − | − | − |
| H | − | − | − | − | − | − | − | − | − | − | − | − |

The results in Table 17 show that only the spore containing patches treated with both laccase, potassium iodide and enhancing agent (methylsyringate) are effectively disinfected.

### Example 8

Thiosulphate Quenching of the Sporocidal Effect

The following reagents were prepared:
DMG buffer (3,3-DiMethylGlutaric acid, Sigma D4379), 50 mM, pH adjusted to 6.5 with NaOH;
Bacillus thuringiensis Spores were re-suspended in DMG buffer to a density of 2×10⁹ spores per ml;
Myceliophthora thermophila laccase (as disclosed in WO 95/33836, SEQ ID NO:1; and available from Novozymes A/S) was diluted to 6000 microgram per ml in DMG buffer;
200 mM Potassium iodide (KI) solution in water;
1 mM Methylsyringate (methyl 3,5-dimethoxy-4-hydroxybenzoate, Sigma S40,944-8) solution in ethanol/DMG buffer (1:1);
Sterile water;
10% (WN) sodium thiosulphate;
3 mM MTT (3-(4,5-Dimethylthiazol-yl)-2,5-diphenyltetrazolium bromide, Sigma M2128) solution in water.

TBB growth medium:
10 g/l Tryptose,
3 g/l Beef Extract,
5 g/l NaCl,
water ad 1000 ml
final pH 7.2+/−0.2.

Spore suspension was pipetted into the wells in row A of 5 microtiter plates. The other reagents were added as indicated in table 18 below. The reaction was initiated by the addition of laccase solution. The microtiter plates was then preincubated at 30 degrees Celsius for the specified times: one for 15 minutes, one for 30 minutes, one for 1 hour, one for 2 hours and one for 22 hours.

At the end of the preincubation 50 microliter 10% (w/v) sodium thiosulphate was added to each well in row A and the plate was allowed to incubate a further 60 minutes at room temperature (approx. 24 degrees Celsius).

TABLE 18
Microtiter plate setup.

| | | | | | | Sodium- | |
|---|---|---|---|---|---|---|---|
| | DMG | | | | Methyl- | Thiosulphate | Water |
| | buffer | Spores | Laccase | KI | syringate | (microliter) | (microliter) |
| Wells | (microliter) | (microliter) | (microliter) | (microliter) | (microliter) | (*) | (*) |
| A1-3 | 123 | 50 | 8 | 6.25 | 12.5 | 50 | 0 |
| A4-6 | 123 | 50 | 8 | 6.25 | 12.5 | 0 | 50 |
| A7-9 | 150 | 50 | 0 | 0 | 0 | 50 | 0 |
| A10-12 | 150 | 50 | 0 | 0 | 0 | 0 | 50 |

(*) Added after 15 and 30 minutes and after 1, 2 and 22 hours preincubation.

180 microliter TBB growth medium was added to all wells in rows B to H of the microtiter plate. Then serial 10 fold dilutions were made by pipetting 20 microliter from row A to row B, and then from row B to row C, and then from row C to row D, and so on until row H.

The microtiter plates were incubated at 30 degrees Celsius for 20-24 hours to allow spores to germinate and grow. Growth was evaluated by a microplate reader and visually by “developing the growth” by addition of 5 microliter 3 mM MTT to each well. Formation of purple formazans reveals bacterial growth and thus the degree of spore inactivation. The difference in growth between the control without laccase and the laccase killing mixture, where growth can be detected, directly gives the killing potential in log units.

TABLE 19
Results of evaluation of growth. 15 minutes
preincubation followed by quenching.

| | 1 | 2 | 3 | 4 | 5 | 6 | 7 | 8 | 9 | 10 | 11 | 12 |
|---|---|---|---|---|---|---|---|---|---|---|---|---|
| A | | | | | | | | | | | | |
| B | + | + | + | + | + | + | + | + | + | + | + | + |
| C | + | + | + | + | + | + | + | + | + | + | + | + |
| D | + | + | + | − | − | + | + | + | + | + | + | + |
| E | + | + | + | − | − | − | + | + | + | + | + | + |
| F | + | − | + | − | − | − | + | + | + | + | + | + |
| G | − | − | − | − | − | − | + | − | + | − | + | + |
| H | − | − | − | − | − | − | − | − | − | − | + | − |

TABLE 20
Results of evaluation of growth. 1 hours preincubation.

| | 1 | 2 | 3 | 4 | 5 | 6 | 7 | 8 | 9 | 10 | 11 | 12 |
|---|---|---|---|---|---|---|---|---|---|---|---|---|
| A | | | | | | | | | | | | |
| B | + | + | + | + | − | − | + | + | + | + | + | + |
| C | + | + | + | + | − | − | + | + | + | + | + | + |
| D | − | + | − | − | − | − | + | + | + | + | + | + |
| E | − | − | − | − | − | − | + | + | + | + | + | + |
| F | − | − | − | − | − | − | + | + | + | + | + | + |
| G | − | − | − | − | − | − | + | + | + | + | + | + |
| H | − | − | − | − | − | − | − | − | + | − | − | − |

TABLE 21
Results of evaluation of growth. 2 hours preincubation

| | 1 | 2 | 3 | 4 | 5 | 6 | 7 | 8 | 9 | 10 | 11 | 12 |
|---|---|---|---|---|---|---|---|---|---|---|---|---|
| A | | | | | | | | | | | | |
| B | − | + | + | + | + | − | + | + | + | + | + | + |
| C | − | − | − | − | − | − | + | + | + | + | + | + |
| D | − | − | − | − | − | − | + | + | + | + | + | + |
| E | − | − | − | − | − | − | + | + | + | + | + | + |
| F | − | − | − | − | − | − | + | + | + | + | + | + |
| G | − | − | − | − | − | − | + | + | − | + | − | + |
| H | − | − | − | − | − | − | − | − | − | − | − | − |

TABLE 22
Results of evaluation of growth. 4 hours preincubation.

| | 1 | 2 | 3 | 4 | 5 | 6 | 7 | 8 | 9 | 10 | 11 | 12 |
|---|---|---|---|---|---|---|---|---|---|---|---|---|
| A | | | | | | | | | | | | |
| B | − | − | − | − | − | − | + | + | + | + | + | + |
| C | − | − | − | − | − | − | + | + | + | + | + | + |
| D | − | − | − | − | − | − | + | + | + | + | + | + |
| E | − | − | − | − | − | − | + | + | + | + | + | + |
| F | − | − | − | − | − | − | + | + | + | + | + | + |
| G | − | − | − | − | − | − | − | + | + | + | + | + |
| H | − | − | − | − | − | − | − | − | − | − | − | − |

TABLE 23
Results of evaluation of growth. 22 hours preincubation.

| | 1 | 2 | 3 | 4 | 5 | 6 | 7 | 8 | 9 | 10 | 11 | 12 |
|---|---|---|---|---|---|---|---|---|---|---|---|---|
| A | | | | | | | | | | | | |
| B | − | − | − | − | − | − | + | + | + | + | + | + |
| C | − | − | − | − | − | − | + | + | + | + | + | + |
| D | − | − | − | − | − | − | + | + | + | + | + | + |
| E | − | − | − | − | − | − | + | + | + | + | + | + |
| F | − | − | − | − | − | − | + | + | + | + | + | + |
| G | − | − | − | − | − | − | − | + | − | + | + | + |
| H | − | − | − | − | − | − | − | − | − | − | + | − |

Thiosulphate is known to oxidise iodide very efficiently. The spore inactivation patterns demonstrates that incubation of spores with the laccase system for more than 1 hour, results in irreversible spore inactivation.

### Example 9

NaOH Quenching of the Sporocidal Effect

The following reagents were prepared:
DMG buffer (3,3-DiMethylGlutaric acid, Sigma D4379), 50 mM, pH adjusted to 6.5 with NaOH;
Bacillus thuringiensis spores were re-suspended in DMG buffer to a density of 2×10⁹ spores per ml;
Myceliopthora thermophila laccase (as disclosed in WO 95/33836, SEQ ID NO: 1; and available from Novozymes A/S) was diluted to 6000 microgram per ml in DMG buffer;
200 mM Potassium iodide (KI) solution in water;
1 mM Methylsyringate (methyl 3,5-dimethoxy-4-hydroxybenzoate, Sigma S40,944-8) solution in ethanol/DMG buffer (1:1);
Sterile water;
0.5 M Sodium hydroxide (NaOH);
0.5 M Hydrochloric Acid (HCl)
3 mM MTT (3-(4,5-Dimethylthiazol-yl)-2,5-diphenyltetrazolium bromide, Sigma M2128) solution in water.

TBB growth medium:
10 g/l Tryptose,
3 g/l Beef Extract,
5 g/l NaCl,
water ad 1000 ml
final pH 7.2+/−0.2.

Spore suspension was pipetted into the wells in row A of five microtiter plates. The other reagents were added as indicated in table 24 below. The reaction was initiated by the addition of laccase solution. The five microtiter plates were then preincubated at 30 degrees Celsius for 15 minutes, 30 minutes, 1 hour, 2 hours and 22 hours.

At the end of the incubation 25 microliter 0.5 M sodium hydroxide was added to specified wells in row A, se table 23. Following a further incubation period of 60 minutes the added NaOH was neutralized by the addition of 25 microliter 0.5 M HCl.

TABLE 24
Microtiter plate setup.

| | DMG | | | | Methyl- | NaOH | Water | HCl |
|---|---|---|---|---|---|---|---|---|
| | buffer | Spores | Laccase | KI | syringate | (micro- | (micro- | (micro- |
| | (micro- | (micro- | (micro- | (micro- | (micro- | liter) | liter) | liter) |
| Wells | liter) | liter) | liter) | liter) | liter) | (*) | (*) | (**) |
| A1-3 | 123 | 50 | 8 | 6.25 | 12.5 | 25 | 0 | 25 |
| A4-6 | 123 | 50 | 8 | 6.25 | 12.5 | 0 | 50 | 0 |
| A7-9 | 150 | 50 | 0 | 0 | 0 | 25 | 0 | 25 |
| A10-12 | 150 | 50 | 0 | 0 | 0 | 0 | 50 | 0 |

(*) Added after 15, 30 minutes and after 1 hour 2 hours and 22 hours preincubation.
(**) Added after 60 minutes incubation with NaOH.

180 microliter TBB growth medium was added to all wells in rows B to H of the microtiter plate. Then serial 10 fold dilutions were made by pipetting 20 microliter from row A to row B, and then from row B to row C, and then from row C to row D, and so on until row H.

The microtiter plates were incubated at 30 degrees Celsius for 20-24 hours to allow spores to germinate and grow. Growth was evaluated by a microplate reader and visually by “developing the growth” by addition of 5 microliter 3 mM MTT to each well. Formation of purple formazans reveals bacterial growth and thus the degree of spore inactivation

TABLE 25
Inactivation of spores by the laccase
system. 15 minutes preincubation

| | 1 | 2 | 3 | 4 | 5 | 6 | 7 | 8 | 9 | 10 | 11 | 12 |
|---|---|---|---|---|---|---|---|---|---|---|---|---|
| A | | | | | | | | | | | | |
| B | + | + | + | + | + | + | + | + | + | + | + | + |
| C | + | + | + | + | + | + | + | + | + | + | + | + |
| D | + | + | + | + | + | + | + | + | + | + | + | + |
| E | + | + | + | − | + | − | + | + | + | + | + | + |
| F | + | − | − | − | − | − | + | + | + | + | + | + |
| G | − | − | − | − | − | − | + | + | + | + | − | − |
| H | − | − | − | − | − | − | − | − | − | − | − | − |

TABLE 26
Inactivation of spores by the laccase system. 1 hour preincubation

| | 1 | 2 | 3 | 4 | 5 | 6 | 7 | 8 | 9 | 10 | 11 | 12 |
|---|---|---|---|---|---|---|---|---|---|---|---|---|
| A | | | | | | | | | | | | |
| B | + | + | + | + | + | + | + | + | + | + | + | + |
| C | + | + | + | + | − | − | + | + | + | + | + | + |
| D | + | − | + | − | − | + | + | + | + | + | + | + |
| E | − | − | − | − | − | − | + | + | + | + | + | + |
| F | − | − | − | − | − | − | + | + | + | + | + | + |
| G | − | − | − | − | − | − | + | + | + | + | + | + |
| H | − | − | − | − | − | − | − | − | + | − | + | − |

TABLE 27
Inactivation of spores by the laccase
system. 2 hours preincubation

| | 1 | 2 | 3 | 4 | 5 | 6 | 7 | 8 | 9 | 10 | 11 | 12 |
|---|---|---|---|---|---|---|---|---|---|---|---|---|
| A | | | | | | | | | | | | |
| B | + | + | + | − | − | − | + | + | + | + | + | + |
| C | − | + | − | − | − | − | + | + | + | + | + | + |
| D | − | − | − | − | − | − | + | + | + | + | + | + |
| E | − | − | − | − | − | − | + | + | + | + | + | + |
| F | − | − | − | − | − | − | + | + | + | + | + | + |
| G | − | − | − | − | − | − | + | + | + | + | + | − |
| H | − | − | − | − | − | − | + | − | − | − | − | − |

TABLE 28
Inactivation of spores by the laccase
system. 4 hours preincubation

| | 1 | 2 | 3 | 4 | 5 | 6 | 7 | 8 | 9 | 10 | 11 | 12 |
|---|---|---|---|---|---|---|---|---|---|---|---|---|
| A | | | | | | | | | | | | |
| B | − | − | + | − | − | − | + | + | + | + | + | + |
| C | − | − | − | − | − | − | + | + | + | + | + | + |
| D | − | − | − | − | − | − | + | + | + | + | + | + |
| E | − | − | − | − | − | − | + | + | + | + | + | + |
| F | − | − | − | − | − | − | + | + | + | + | + | + |
| G | − | − | − | − | − | − | + | + | + | + | + | − |
| H | − | − | − | − | − | − | + | − | + | − | − | − |

TABLE 29
Inactivation of spores by the laccase
system. 22 hours preincubation.

| | 1 | 2 | 3 | 4 | 5 | 6 | 7 | 8 | 9 | 10 | 11 | 12 |
|---|---|---|---|---|---|---|---|---|---|---|---|---|
| A | | | | | | | | | | | | |
| B | − | − | − | − | − | − | + | + | + | + | + | + |
| C | − | − | − | − | − | − | + | + | + | + | + | + |
| D | − | − | − | − | − | − | + | + | + | + | + | + |
| E | − | − | − | − | − | − | + | + | + | + | + | + |
| F | − | − | − | − | − | − | + | + | + | + | + | + |
| G | − | − | − | − | − | − | − | + | − | + | + | + |
| H | − | − | − | − | − | − | − | − | − | − | + | − |

Incubating spores (preincubated with laccase system) with an alkalihydroxide reverses the inactivation to some extent. The longer the laccase system acts on the spores the greater the nonreversible inactivation is obtained. Preincubation for more than 4 hours practically renders the spores unable to germinate.

1. A sporocidal composition comprising a laccase or a compound exhibiting laccase activity, a source of oxygen, a source of iodide ions and an enhancing agent.

2. The composition of claim 1, wherein the source of iodide ions is one or more salts of iodide.

3. The composition of claim 1, which further comprises a surfactant.

4. An enzymatic method of killing or inactivating spores, comprising contacting the spores with a laccase or a compound exhibiting laccase activity, a source of oxygen, a source of iodide ions and an enhancing agent.

5. The method of claim 4, wherein the source of iodide ions is one or more salts of iodide.

6. The method of claim 4, which further comprises contacting the spores with a surfactant.

7. The method of claim 4, wherein the spores are located on a surface.

8. The method of claim 7, wherein the surface is a textile surface.

9. The method of claim 7, wherein the surface is a surface of laboratory or process equipment.

10. A method of decontaminating a location, which has been exposed to spores, comprising contacting the spores with a laccase or a compound exhibiting laccase activity, a source of oxygen, a source of iodide ions and an enhancing agent.

11. The method of claim 10, wherein the source of iodide ions is one or more salts of iodide.

12. The method of claim 10, which further comprises contacting the spores with a surfactant.

13. A container comprising the composition of claim 1, wherein the components of the composition are packaged in one or more compartments or layers.

14. A ready-to-use sporocidal formulation comprising the composition of claim 1.

15. (canceled)
